(19) United States
(12) Patent Application Publication
(10) Pub. No.: US 2023/0036338 A1
(43) Pub. Date: Feb. 2, 2023

(54) METHOD AND APPARATUS FOR GENERATING IMAGE RESTORATION MODEL, MEDIUM AND PROGRAM PRODUCT

(71) Applicant: Beijing Baidu Netcom Science Technology Co., Ltd., Beijing (CN)

(72) Inventors: Fanglong Liu, Beijing (CN); Xin Li, Beijing (CN); Dongliang He, Beijing (CN)

(73) Assignee: Beijing Baidu Netcom Science Technology Co., Ltd., Beijing (CN)

(21) Appl. No.: 17/963,384

(22) Filed: Oct. 11, 2022

Related U.S. Application Data
(63) Continuation of application No. PCT/CN2022/075070, filed on Jan. 29, 2022.

(30) Foreign Application Priority Data
Apr. 29, 2021 (CN) 202110475219.7

(51) Int. Cl. G06T 5/00; G06T 5/50; G06V 40/16

(52) U.S. Cl. CPC G06T 5/001; G06T 5/50; G06V 40/172; G06T 2207/20084; G06T 2207/30201

(57) ABSTRACT

A method and apparatus for generating an image restoration model, a medium and a program product are provided. The method includes: obtaining a first image and a second image, wherein the second image is an image obtained by restoring the first image; synthesizing images corresponding to feature points of the first image and the first image to obtain a synthesized image; and performing training by using the second image and the synthesized image to obtain an image restoration model.

### CROSS-REFERENCE TO RELATED APPLICATIONS

The patent application is a continuation of International Application No. PCT/CN2022/075070, filed on Jan. 29, 2022, which claims the priority to Chinese Patent Application No. 202110475219.7, filed on Apr. 29, 2021, entitled “METHOD AND APPARATUS FOR GENERATING IMAGE RESTORATION MODEL, MEDIUM AND PROGRAM PRODUCT”. Both of the aforementioned applications are hereby incorporated by reference in their entireties.

### TECHNICAL FIELD

Embodiments of the present disclosure relate to the field of computers, more particularly, to the field of artificial intelligence such as deep learning and computer vision, and more particularly, to a method and apparatus for generating an image restoration model, a medium and a program product.

### BACKGROUND

In those years when digital cameras and digital storage devices were not popularized, people can take photos, and develop them to save and record beautiful moments. However, due to disadvantages of photographic paper, scratches, color fading, stains, and the like can easily appear in a process of storing, which seriously affects a visual quality of a photo.

Currently, a to-be-restored image is restored manually through professional software to complete image restoration.

### SUMMARY

Embodiments of the present disclosure provide a method and apparatus for generating an image restoration model, a medium and a program product.

Some embodiments of the present disclosure provide a method for generating an image restoration model. The method may include: obtaining a first image and a second image, where the second image is an image obtained by restoring the first image; synthesizing images corresponding to feature points of the first image and the first image to obtain a synthesized image; and performing training by using the second image and the synthesized image to obtain an image restoration model.

Some embodiments of the present disclosure provide an apparatus for generating an image restoration model. The apparatus may include: an image obtaining module, configured to obtain a first image and a second image, where the second image is an image obtained by restoring the first image; an image synthesizing module, configured to synthesize images corresponding to feature points of the first image and the first image to obtain a synthesized image; and a model training module, configured to perform training by using the second image and the synthesized image to obtain an image restoration model.

Some embodiments of the present disclosure provide a method for restoring an image. The method may include: obtaining a to-be-restored image; and inputting the to-be-restored image into a pre-trained image restoration model to obtain a restored image.

Some embodiments of the present disclosure provide an apparatus for restoring an image. The apparatus may include: an image obtaining module, configured to obtain a to-be-restored image; and an image restoring module, configured to input the to-be-restored image into a pre-trained image restoration model to obtain a restored image.

Some embodiments of the present disclosure provide an electronic device. The electronic device may include: at least one processor; and a memory in communication with the at least one processor; where the memory stores instructions executable by the at least one processor, and the instructions, when executed by the at least one processor, cause the at least one processor to perform the above methods.

Some embodiments of the present disclosure provide a non-transitory computer readable storage medium storing computer instructions, wherein, the computer instructions are used to cause the computer to perform the above methods.

Some embodiments of the present disclosure provide a computer program product. The computer program product may include a computer program/instruction, the computer program/instruction, when executed by a processor, implements the above methods.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

Other features, objectives and advantages of the present disclosure will become more apparent upon reading the detailed description of non-limiting embodiment with reference to the following accompanying drawings. The accompanying drawings are used for a better understanding of the scheme, and do not constitute a limitation to the present disclosure. Here:

FIG. 1 is an exemplary system architecture diagram to which the present disclosure may be applied;

FIG. 2 is a flowchart of a method for generating an image restoration model according to an embodiment of the present disclosure;

FIG. 3 is a flowchart of a method for generating an image restoration model according to another embodiment of the present disclosure;

FIG. 4 is a flowchart of a method for restoring an image according to an embodiment of the present disclosure;

FIG. 5 is an application scenario of a method for restoring an image according to the present disclosure;

FIG. 6 is a schematic structural diagram of an apparatus for generating an image restoration model according to an embodiment of the present disclosure;

FIG. 7 is a schematic structural diagram of an apparatus for restoring an image according to an embodiment of the present disclosure; and

FIG. 8 is a block diagram of an electronic device adapted to implement an embodiment of the present disclosure.

### DETAILED DESCRIPTION OF EMBODIMENTS

Exemplary embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description.

It should be noted that the embodiments of the present disclosure and features of the embodiments may be combined with each other on a non-conflict basis. The present disclosure will be described below in detail with reference to the accompanying drawings and in combination with the embodiments.

FIG. 1 illustrates an exemplary system architecture 100 to which a method of generating an image restoration model or an apparatus for generating an image restoration model according to an embodiment of the present disclosure may be applied.

As shown in FIG. 1, the system architecture 100 may include terminal devices 101, 102, 103, a network 104, and a server 105. The network 104 serves as a medium for providing a communication link between the terminal devices 101, 102, 103 and the server 105. The network 104 may include various types of connections, such as wired, wireless communication links, or fiber optic cables, and the like.

A user may use the terminal devices 101, 102, and 103 to interact with the server 105 via the network 104 to receive or send video frames, or the like. Various client applications and intelligent interactive applications, such as image processing applications and the like, may be installed on the terminal devices 101, 102, and 103.

The terminal devices 101, 102, and 103 may be hardware or software. When the terminal devices 101, 102, and 103 are hardware, the terminal devices may be electronic products that perform human-computer interaction with a user through one or more of a keyboard, a touch pad, a touch screen, a remote controller, a voice interaction, or a handwriting device, such as a PC (Personal Computer), a mobile phone, a smartphone, a PDA (Personal Digital Assistant), a wearable device, a PPC (Pocket PC), a tablet computer, a intelligent vehicle, a smart TV, a smart speaker, a tablet computer, a laptop portable computer, a desktop computer, and the like. When the terminal devices 101, 102, and 103 are software, they may be installed in the above electronic devices. It may be implemented as a plurality of software or software modules, or as a single software or software module. It is not specifically limited herein.

The server 105 may provide various services. For example, the server 105 may analyze and process videos displayed on the terminal devices 101, 102, and 103, and generate a processing result.

It should be noted that the server 105 may be hardware or software. When the server 105 is hardware, it may be implemented as a distributed server cluster of multiple servers, or it may be implemented as a single server. When the server 105 is software, it may be implemented as a plurality of software or software modules (e.g., for providing distributed services), or it may be implemented as a single software or software module. It is not specifically limited herein.

It should be stated that a method for generating an image restoration model provided in an embodiment of the present disclosure is generally performed by the server 105, and accordingly, an apparatus for generating an image restoration model is generally provided in the server 105.

It should be understood that the number of the terminal devices, the networks and the servers in FIG. 1 is merely illustrative. There may be any number of the terminal devices, the networks and the servers as desired for implementation.

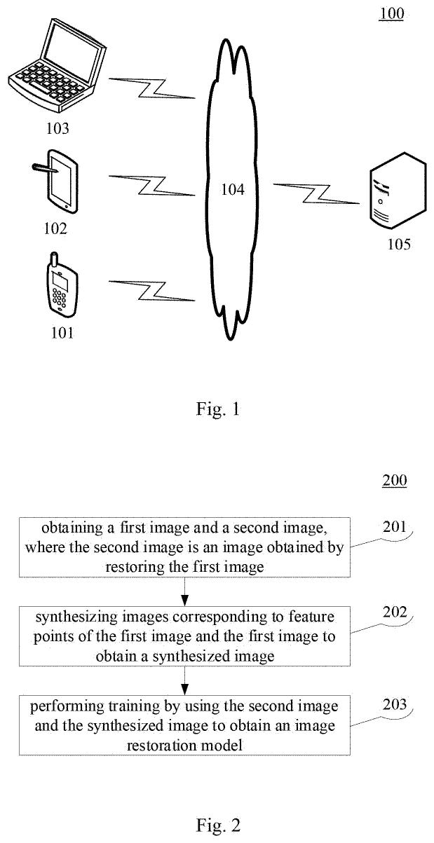

Further referring to FIG. 2, FIG. 2 illustrates a flow 200 of a method for generating an image restoration model according to an embodiment of the present disclosure. The method for generating an image restoration model may include the following step 201 to step 203.

Step 201 includes: obtaining a first image and a second image, where the second image is an image obtained by restoring the first image.

In this embodiment, an execution body (for example, the terminal devices 101, 102, and 103 shown in FIG. 1) of a method for generating an image restoration model may obtain the first image and the second image by a photographing apparatus, which may be a camera of the terminal device or an external camera thereof. Alternatively, the execution body (for example, the server 105 shown in FIG. 1) of the method for generating an image restoration model obtains the first image and the second image from the terminal device (for example, the terminal devices 101, 102, and 103 shown in FIG. 1). The first image may be a certain image to be restored, or one or several frames of images to be restored in a video stream, the first image may include one or more to-be-restored regions, and the second image may be an image obtained by restoring the to-be-restored regions in the first image.

In the present embodiment, the obtaining the first image and the second image may include: obtaining the second image, and generating the first image according to the second image.

The generating the first image according to the second image may include:

(1) generating the first image by damaging the second image using preset mask images, where the preset masks image may be randomly generated noises.

In an example, masks each with an identical size are applied to the second image to obtain the first image.

(2) obtaining the first image by multiplying the second image by a binary mask.

(3) obtaining the first image by adding noise to the second image.

In the present embodiment, when a number of first images is small, the first images can be obtained by processing the second images, so as to increase training samples for training the image restoration model, thereby improving an image restoration accuracy of the image restoration model.

In the present embodiment, after obtaining the first image, the method for generating an image restoration model may further include: determining to-be-restored regions of the first image.

Correspondingly, in the present embodiment, the determining the to-be-restored regions of the first image may include: determining the to-be-restored regions of the first image by identifying the first image with a model; or determining the to-be-restored regions of the first image by manual labelling.

The model is mainly based on the Artificial Intelligence (AI), for example, a neural network model, which can specifically identify the to-be-restored regions of the first image based on an object detection algorithm or the like, for example, an R-FCN, a Faster R-CNN, an SSD, and a YOLO V3 algorithm. These neural network models can be obtained by training an initial neural network model by labelling to-be-restored regions of the first image.

Here, the second image may be an image obtained by restoring the first image.

It should be noted that image restoration refers to restoration and reconstruction of a damaged image or removal of redundant objects in an image.

As one of image processing techniques, the image restoration technique in an embodiment of the present disclosure is intended to restore missing or occluded portions of an image according to an image context, and an image restoration task requires that the restored image, as a whole, should be as natural as possible and as close as possible to an original image. By the image restoration technique, some noise, scratches, missing parts, occlusions, and the like in the image can be removed to improve the image quality.

Step 202 includes synthesizing images corresponding to feature points of the first image and the first image to obtain a synthesized image.

In the embodiment, the execution body may synthesize the images corresponding to the feature points of the first image and the first image to obtain the synthesized image.

Specifically, object detection is firstly performed on the first image; thereafter, an object in the first image is determined; then, feature points of the object in the first image are obtained by feature point detection of the object; then, the feature points are separated from the first image to obtain images corresponding to the feature points; then, the images corresponding to the feature points and the first image are synthesized to obtain then synthesized image. For example, synthesis is performed based on a number of channels of the images corresponding to the feature points of the first image and a number of channels of the first image, to obtain the synthesized image. Alternatively, target feature points in the images corresponding to feature points are spliced with target feature points in the first image, where positions of the target feature points in the images corresponding to the feature points are identical with those of the target feature points in the first image. The above feature point may be used to represent a feature of an object, and the target feature point may represent one or more of all the features of the object. The above object may be a target in the first image, for example, a face, a vehicle, background, a text, or the like.

In a specific example, the first image may be an image including a human face. After performing the object detection on the first image, a type of an object in the first image is determined as a human face and a position of the human face in the first image is determined. Then, key point detection is performed on the human face in the first image to obtain key points of the human face, for example, sense organs on a face (i.e., eyes, eyebrows, the mouth, the nose, etc.), a contour, and the like. Then, the key points of the human face in the first image are separated to obtain images corresponding to the key points of the human face. Then, the images corresponding to the key points of the human face and the feature points with identical positions in the first image are synthesized to obtain a synthesized image. For example, a left eye (that is, the image corresponding to a key point of the human face) is spliced with a left eye in the first image.

Accordingly, in the example, the performing the object detection on the first image may include: performing object detection on the first image by using an image recognition model, and obtaining a type of a target object and a position of the target object in the first image. The above-described image recognition model may be obtained by training a neural network through a sample image of training samples in the training sample set as an input, and a label corresponding to the input sample image (e.g., an position of a object in the sample image, and a type label of the object) as an output, for using as a target recognition model. The target recognition model may be used to determine a position and/or a type of an object in the first image.

After determining the to-be-restored regions of the first image in step 201, the synthesizing the images corresponding to feature points of the first image and the first image to obtain the synthesized image may include: synthesizing images corresponding to feature points of a target region to be restored in the first image and the first image to obtain the synthesized image.

Step 203 includes performing training by using the second image and the synthesized image to obtain an image restoration model.

In the present embodiment, the above-described execution body may perform training by using the second image and the synthesized image to obtain the image restoration model.

Specifically, the above-described execution body may train an initial model by using the synthesized image as an input of the image restoration model and using the second image as an output of the image restoration model to obtain the image restoration model.

In this embodiment, after obtaining the synthesized image and the second image, the execution body can train the initial model by using the synthesized image and the second image to obtain the image restoration model. During training, the execution body may use the synthesized image as an input of the image restoration model, and use the second image corresponding to the input as a desired output to obtain the image restoration model. The above initial model may be a neural network model in the existing technologies or future technologies. For example, the neural network model may include any one of: Generative Adversarial Networks (GAN), Cycle GAN, Pix2pixGAN, Dual GAN, Disco GAN, deep convolutional GAN (DCGAN). The GAN may include a generator and a discriminator. The discriminator is configured to distinguish the first image from the second image. Under supervision of the discriminator, the generator tries to generate a result close to a real image to confuse the discriminator and reduce a loss, so that it is possible to obtain a model in which the first image (that is, an image with a defective region) can be automatically restored.

It should be noted that the above-mentioned generator may be a convolutional neural network (for example, various convolutional neural network structures including a convolutional layer, a pooling layer, an anti-pooling layer, and a deconvolution layer, in which sequential down-sampled and up-sampled can be performed). The above discriminator may also be a convolutional neural network (for example, various convolutional neural network structures including a full connection layer which may implement a classification function). Further, the discriminator may be another model structure that may be used to implement a classification function, for example, a Support Vector Machine (SVM).

In a method and apparatus for generating an image restoration model, a medium and a program product provided by the embodiments of the present disclosure, firstly, a first image and a second image are obtained, where the second image is an image obtained by restoring the first image; then, images corresponding to feature points of the first image and the first image are synthesized to obtain a synthesized image; finally, training is performed by using the second image and the synthesized image to obtain an image restoration model. The synthesized image obtained by synthesizing the first image and the images corresponding to feature points of the first image is used for model training in combination with the second image to obtain the image restoration model, so as to realize the image restoration.

In some alternative implementations of the present embodiment, the synthesizing the images corresponding to the feature points of the first image and the first image to obtain the synthesized image, includes: performing synthesis based on a number of channels of the images corresponding to the feature points of the first image and a number of channels of the first image, to obtain the synthesized image.

In this implementation, the execution body may obtain the synthesized image based on a sum of the number of channels of the images corresponding to the feature points of the first image and the number of channels of the first image.

In this implementation, the execution body may perform synthesis based on the number of channels of the images corresponding to the feature points and the number of channels of the first image, to obtain the synthesized image.

In some alternative implementations of the present embodiment, the feature points of the first image may include feature points of first target regions to be restored in the first image.

In the present implementation, after obtaining the first target regions to be restored of the first image, the method for generating an image restoration model may further include:

performing synthesis based on a number of channels of the images corresponding to feature points of the first target regions to be restored in the first image and the number of the channels of the first image, to obtain the synthesized image. The first target regions to be restored may be one or more to-be-restored regions in the first image.

It should be noted that the feature points of the first target regions to be restored may be all the feature points of the first target regions to be restored. The feature points of the first target regions to be restored may also be relatively important feature points in the first target regions to be restored, such as sense organs on a face, facial contours, and the like.

In the present implementation, image synthesis may be performed based on images corresponding to the feature points of first target regions to be restored and the first image to obtain the synthesized image. As such, while the synthesized image is obtained, resource consumption caused by synthesizing other feature points (for example, feature points other than the feature points of the first target regions to be restored) can be reduced.

In some alternative implementations of the present embodiment, the image restoration model is a generative adversarial model, and the generative adversarial model may include the discriminator and the generator.

In the present implementation, the generative adversarial model may include a generator G and a discriminator D. The generator G may be configured to adjust a resolution of an input image (e.g., the synthesized image) and output the adjusted image, and the discriminator D is configured to determine whether the input image is an image output by the generator G. The generative adversarial model trains the generator G and the discriminator D simultaneously through a continuous adversarial process. During the training, the generator G and the discriminator D are cross-optimized, the generator G is trained to generate a false image to deceive the discriminator D, and the discriminator D is trained to distinguish a false image generated by the generator G from a real image. The generator G is configured to generate an initial restored image based on the synthesized image. Then, the discriminator D determines whether the initial restored image is consistent with the real image (restored image, i.e., the second image). If not, it continues to adjust parameters of the generative adversarial model and, until the initial restored image is consistent with the real image, the adjusting of the model parameters is stopped, and the finally obtained model is determined as the image restoration model.

In the present implementation, the image restoration may be realized based on the generative adversarial model including the discriminator and the generator.

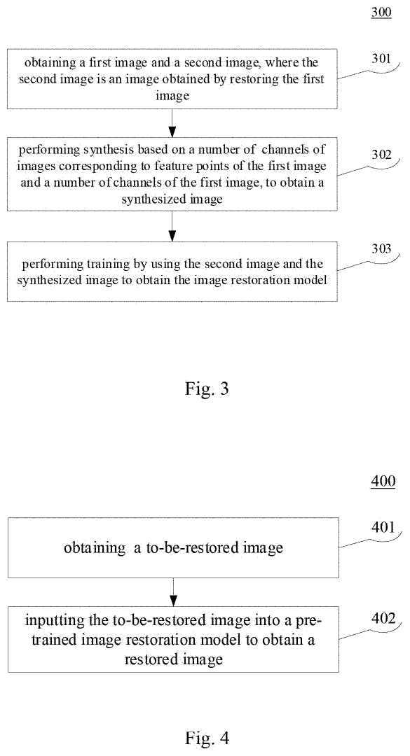

Further referring to FIG. 3, FIG. 3 illustrates a flow 300 of a method for generating an image restoration model according to another embodiment of the present disclosure. The method for generating an image restoration model may include the following step 301 to step 303.

Step 301 includes: obtaining a first image and a second image, where the second image is an image obtained by restoring the first image.

Step 302 includes: performing synthesis based on a number of channels of images corresponding to feature points of the first image and a number of channels of the first image, to obtain a synthesized image.

In the present embodiment, the execution body (for example, the terminal devices 101, 102, and 103, or the server 105 shown in FIG. 1) of the method for generating an image restoration model may perform synthesis based on the number of channels of the images corresponding to the feature points of the first image and the number of channels of the first image, to obtain the synthesized image. A number of channels of the synthesized image may be a sum of the number of channels of the images corresponding to the feature points and the number of channels of the first image. A number of channels may be configured to represent features in multiple dimensions of the image, and the number of channels of the first image may be obtained while the first image is obtained.

Step 303 includes: performing training by using the second image and the synthesized image to obtain the image restoration model.

In the embodiment, the specific operations of steps 301 and 303 have been described in detail in steps 201 and 203, respectively, of the embodiment shown in FIG. 2, and details are not described herein.

As can be seen from FIG. 3, the method for generating an image restoration model in the present embodiment highlights the step of image synthesizing as compared with the embodiment in FIG. 2. Thus, in the solution described in the embodiment, synthesizing is performed based on the number of channels of the images corresponding to the feature points of the first image and the number of channels of the first image to obtain the synthesized image.

Further referring to FIG. 4, FIG. 4 illustrates a flow 400 of a method for restoring an image according to an embodiment of the present disclosure. The method for restoring an image may include the following step 401 to step 402.

Step 401 includes: obtaining a to-be-restored image.

In the present embodiment, the execution body of the method for restoring an image may be the same as or different from the execution body of the method for generating an image restoration model. If the two execution bodies are the same one, the execution body of the method for generating an image restoration model may store model structure information and parameter values of model parameters of the trained image restoration model locally after obtaining the image restoration model by training. If the two execution bodies are different from each other, the execution body of the method for generating an image restoration model may send the model structure information and the parameter values of the model parameters of the trained image restoration model to the execution body of the method for restoring an image after obtaining the image restoration model by training.

In the present embodiment, the execution body of the method for restoring an image may obtain the to-be-restored image in a plurality of ways. For example, the to-be-restored image may be acquired by the terminal devices (e.g., the terminal devices 101, 102, and 103 shown in FIG. 1). The to-be-restored image may be an image with a to-be-restored region.

Step 402 includes: inputting the to-be-restored image into a pre-trained image restoration model to obtain a restored image.

In the present embodiment, the above-described execution body may input the to-be-restored image into a pre-trained image restoration model to obtain the restored image. The image restoration model may be a model trained by the method of generating an image restoration model, such as a model trained by the embodiments corresponding to FIG. 2 and FIG. 3.

According to the method provided in the embodiment of the present disclosure, the to-be-restored image can be restored based on the pre-trained image restoration model.

In some alternative implementations of the present embodiment, before performing step 402, the method for restoring an image may further include: determining second target regions to be restored of the to-be-restored image; and separating images corresponding to the second target regions to be restored from the to-be-restored image.

It should be noted that the description of determining the second target regions to be restored in the to-be-restored image may refer to the description of determining the to-be-restored regions in the first image. The second target regions to be restored may be one or more to-be-restored regions in the to-be-restored image.

After determining the second target regions to be restored, the step 402 may include: inputting images corresponding to the second target regions to be restored into the pre-trained image restoration model to obtain the restored image.

In the present implementation, it is possible to restore the second target regions to be restored in the to-be-restored image, so as to simplify a restore operation on the entire to-be-restored image, thereby improving an efficiency of image restoration.

In some alternative implementations of the present embodiment, if the to-be-restored image is a face image, after the restored image is obtained, the method for restoring an image may further include: recognizing the restored image to obtain a recognition result; and performing identity authentication according to the recognition result.

In the present implementation, a face recognition can be performed on the restored image to obtain a face recognition result. Then, matching is performed based on the face recognition result and a standard image, to perform the identity authentication based on a matching result. If the face recognition result is matched with the standard image, then it is determined that the identity authentication is successful. If the face recognition result is not matched with the standard image, then it is determined that the identity authentication fails. The standard image may be an image previously uploaded by the user, through which it is possible to accurately determine whether the user is a legal user.

It should be noted that when performing identity authentication of the user, if the user is in a situation where it is not convenient to shoot (for example, on a vehicle traveling quickly), an image (that is, a to-be-restored image) of the user that is not very clear may be captured by the terminal device. In this case, it is necessary to perform identity authentication on the user, and the captured image can be restored by the image restoration model. After obtaining the restored image, the identity authentication is performed based on the restored image, so that the identity authentication is implemented in the situation where it is not convenient to shoot.

In the present implementation, subsequent operations related to information of the restored image may also be performed based on the restored image after the user is authenticated. For example, recommendation is made based on the information of the restored image (for example in a scene in which an image search is performed), and resource transfer is performed based on the information of the restored image.

In a specific example, a face image for which the resource transfer is to be performed and a preset face image (i.e., the standard image) of an account on which the resource transfer is to be performed are obtained; the face image for which the resource transfer is to be performed is input into the image restoration model; the restored face image is obtained by restoring the face image for which the resource transfer is to be performed through the image restoration model; face recognition is performed on the restored face image to obtain an identity recognition result of the face image; if the identity recognition result indicates that the restored face image is matched with the preset face image preset of the account on which the resource transfer is to be performed, then the resource transfer is performed.

It should be noted that resource transfer may refer to a change in an ownership of resources. For example, the resources are transferred from A (or a device A, or a user A) to B (or a device B, or a user B).

In the present embodiment, after restoring the to-be-restored image to obtain the restored image, the restored image can be recognized to perform identity authentication according to the recognition result.

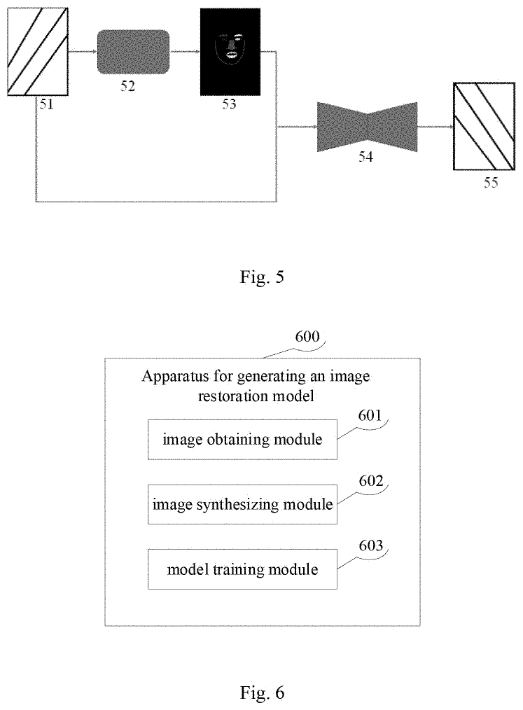

For ease of understanding, an application scenario in which the method for restoring an image of an embodiment of the present disclosure can be implemented is provided below. As shown in FIG. 5, a face image is used as an example, and a terminal device 501 (such as the terminal devices 101, 102, and 103 shown in FIG. 1) is used as an example. First, the terminal device obtains the first image 51. Thereafter, key point detection 52 is performed on the first image to obtain key points (i.e., masks) 53 of the first image. Then, a number of channels of images corresponding to the key points of the first image and a number of channels of the first image are input to a pre-trained image restoration model 54 to obtain a restoration result 55 (for example, the second image).

Further referring to FIG. 6, as an implementation of the method shown in each of the above figures, the present disclosure provides an embodiment of an apparatus for generating an image restoration model, which corresponds to the method embodiment shown in FIG. 2 and is particularly applicable to various electronic devices.

As shown in FIG. 6, the apparatus 600 for generating an image restoration model of the present embodiment may include an image obtaining module 601, an image synthesizing module 602, and a model training module 603. The image obtaining module 601 is configured to obtain a first image and a second image, where the second image is an image obtained by restoring the first image; the image synthesizing module 602 is configured to synthesize images corresponding to feature points of the first image and the first image to obtain a synthesized image; and the model training module 603 is configured to perform training by using the second image and the synthesized image to obtain an image restoration model.

In the present embodiment, in the apparatus 600 for generating an image restoration model, the specific processing and the technical effects of the image obtaining module 601, the image synthesizing module 602, and the model training module 603 may be described with reference to the related description of steps 201 to 203 in the corresponding embodiment in FIG. 2, and details are not described herein again.

In some alternative implementations of the present embodiment, the image synthesizing module 602 is further configured to perform synthesis based on a number of channels of the images corresponding to the feature points of the first image and a number of channels of the first image, to obtain the synthesized image.

In some alternative implementations of the present embodiment, the feature points of the first image are feature points of first target regions to be restored in the first image.

In some alternative implementations of the present embodiment, the image restoration model is a generative adversarial model.

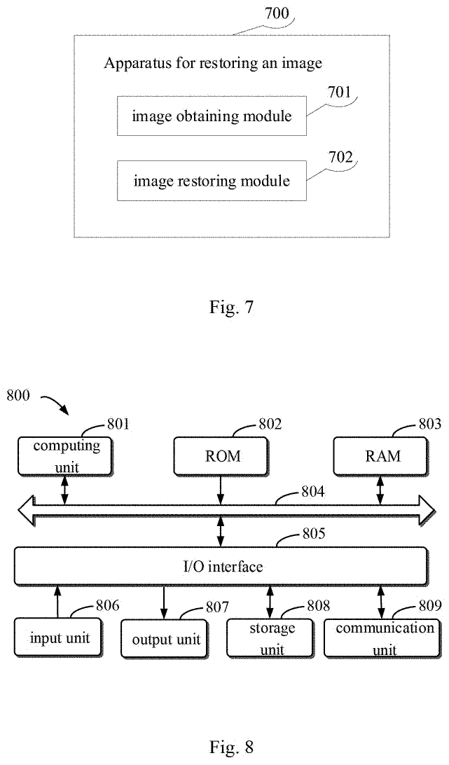

Further referring to FIG. 7, as an implementation of the method shown in each of the above figures, the present disclosure provides an embodiment of an apparatus for restoring an image, which corresponds to the method embodiment shown in FIG. 4 and is particularly applicable to various electronic devices.

As shown in FIG. 7, the apparatus 700 for restoring an image of the present embodiment may include an image obtaining module 701 and an image restoring module 702. The image obtaining module 701 is configured to obtain a to-be-restored image; and the image restoring module 702 is configured to input the to-be-restored image into a pre-trained image restoration model to obtain a restored image.

In the present embodiment, in the apparatus 700 for restoring an image, the specific processing and the technical effects of the image obtaining module 701 and the image restoring module 702 may be described with reference to the related description of steps 401 to 402 in the corresponding embodiment of FIG. 4, and details are not described herein.

In some alternative implementations of the present embodiment, the image restoration apparatus further includes: a region determining module (not shown), configured to determine second target regions to be restored in the to-be-restored image; and the image restoring module 702 is further configured to input images corresponding to the second target regions to be restored into the image restoration model according to any one of claims 1 to 4 to obtain the restored image.

In some alternative implementations of the present embodiment, in a case that the to-be-restored image is a to-be-restored face image, the apparatus for restoring an image further includes: an image recognizing module (not shown) configured to recognize the restored image to obtain a recognition result, and an identity authenticating module (not shown) configured to perform identity authentication based on the identification result.

According to an embodiment of the present disclosure, the present disclosure also provides an electronic device, a readable storage medium, and a computer program product.

FIG. 8 illustrates a schematic block diagram of an example electronic device 800 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 8, the device 800 includes a computing unit 801, which may perform various appropriate actions and processing, based on a computer program stored in a read-only memory (ROM) 802 or a computer program loaded from a storage unit 808 into a random access memory (RAM) 803. In the RAM 803, various programs and data required for the operation of the device 800 may also be stored. The computing unit 801, the ROM 802, and the RAM 803 are connected to each other through a bus 804. An input/output (I/O) interface 805 is also connected to the bus 804.

A plurality of parts in the device 800 are connected to the I/O interface 805, including: an input unit 806, for example, a keyboard and a mouse; an output unit 807, for example, various types of displays and speakers; the storage unit 808, for example, a disk and an optical disk; and a communication unit 809, for example, a network card, a modem, or a wireless communication transceiver. The communication unit 809 allows the device 800 to exchange information/data with other devices over a computer network such as the Internet and/or various telecommunication networks.

The computing unit 801 may be various general-purpose and/or dedicated processing components having processing and computing capabilities. Some examples of the computing unit 801 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 801 performs the various methods and processes described above, such as the method for generating an image restoration model or the method for restoring an image. For example, in some embodiments, the method for generating an image restoration model or the method for restoring an image may be implemented as a computer software program, which is tangibly included in a machine readable medium, such as the storage unit 808. In some embodiments, part or all of the computer program may be loaded and/or installed on the device 800 via the ROM 802 and/or the communication unit 809. When the computer program is loaded into the RAM 803 and executed by the computing unit 801, one or more steps of the method for generating an image restoration model or the method for restoring an image described above may be performed. Alternatively, in other embodiments, the computing unit 801 may be configured to perform the method for generating an image restoration model or the method for restoring an image by any other appropriate means (for example, by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or a combination thereof. The various implementations may include: an implementation in one or more computer programs that are executable and/or interpretable on a programmable system including at least one programmable processor, which may be a special-purpose or general-purpose programmable processor, and may receive data and instructions from, and transmit data and instructions to, a storage system, at least one input apparatus, and at least one output device.

Program codes for implementing the method of the present disclosure may be compiled using any combination of one or more programming languages. The program codes may be provided to a processor or controller of a general-purpose computer, a special-purpose computer, or other programmable apparatuses for processing vehicle-road collaboration information, such that the program codes, when executed by the processor or controller, cause the functions/operations specified in the flow charts and/or block diagrams to be implemented. The program codes may be completely executed on a machine, partially executed on a machine, executed as a separate software package on a machine and partially executed on a remote machine, or completely executed on a remote machine or server.

In the context of the present disclosure, the machine-readable medium may be a tangible medium which may contain or store a program for use by, or used in combination with, an instruction execution system, apparatus or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any appropriate combination of the above. A more specific example of the machine-readable storage medium will include an electrical connection based on one or more pieces of wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, an optical storage device, a magnetic storage device, or any appropriate combination of the above.

To provide interaction with a user, the systems and technologies described herein may be implemented on a computer that is provided with: a display apparatus (e.g., a CRT (cathode ray tube) or a LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or haptic feedback); and an input may be received from the user in any form (including an acoustic input, a voice input, or a tactile input).

The systems and technologies described herein may be implemented in a computing system (e.g., as a data server) that includes a back-end component, or a computing system (e.g., an application server) that includes a middleware component, or a computing system (e.g., a user computer with a graphical user interface or a web browser through which the user can interact with an implementation of the systems and technologies described herein) that includes a front-end component, or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and usually interact via a communication network. The relationship between the client and the server arises by virtue of computer programs that run on corresponding computers and have a client-server relationship with each other. The server may be a cloud server, a distributed system server, or a server combined with a blockchain.

Artificial intelligence is a discipline that studies computers to simulate certain thinking processes and intelligent behaviors of humans (such as learning, reasoning, thinking, planning, etc.). It has both hardware technology and software technology. Artificial intelligence hardware technology generally includes technologies such as sensors, dedicated artificial intelligence chips, cloud computing, distributed storage, and big data processing. Artificial intelligence software technology mainly includes computer vision technology, speech recognition technology, natural speech processing technology, machine learning/deep learning, big data processing technology, knowledge graph technology and other major directions.

It should be understood that the various forms of processes shown above may be used to reorder, add, or delete steps. For example, the steps disclosed in the present disclosure may be executed in parallel, sequentially, or in different orders, as long as the desired results of the technical solutions disclosed in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for generating an image restoration model, comprising:
obtaining a first image and a second image, wherein the second image is an image obtained by restoring the first image;
synthesizing images corresponding to feature points of the first image and the first image to obtain a synthesized image; and
performing training by using the second image and the synthesized image to obtain the image restoration model.

2. The method according to claim 1, wherein performing training by using the second image and the synthesized image to obtain the image restoration model, comprises:
performing synthesis based on a number of channels of the images corresponding to the feature points of the first image and a number of channels of the first image, to obtain the synthesized image.

3. The method according to claim 1, wherein the feature points of the first image are feature points of first target regions to be restored in the first image.

4. The method according to claim 1, wherein the image restoration model is a generative adversarial model.

5. The method according to claim 1, further comprising:
obtaining a to-be-restored image; and
inputting the to-be-restored image into the image restoration model to obtain a restored image.

6. The method according to claim 5, further comprising:
determining second target regions to be restored in the to-be-restored image,
wherein the inputting the to-be-restored image into the image restoration model to obtain the restored image comprises:
inputting images corresponding to the second target regions to be restored into the image restoration model to obtain the restored image.

7. The method according to claim 5, wherein in a case that the to-be-restored image is a to-be-restored face image, the method further comprises:
recognizing the restored image to obtain a recognition result; and
performing identity authentication according to the recognition result.

8. An apparatus for generating an image restoration model, comprising:
at least one processor; and
a memory storing instructions, wherein the instructions when executed by the at least one processor, cause the at least one processor to perform operations, the operations comprising:
obtaining a first image and a second image, wherein the second image is an image obtained by restoring the first image;
synthesizing images corresponding to feature points of the first image and the first image to obtain a synthesized image; and
performing training by using the second image and the synthesized image to obtain the image restoration model.

9. The apparatus according to claim 8, wherein operations further comprise:
performing synthesis based on a number of channels of the images corresponding to the feature points of the first image and a number of channels of the first image, to obtain the synthesized image.

10. The apparatus according to claim 8, wherein the feature points of the first image are feature points of first target regions to be restored in the first image.

11. The apparatus according to claim 8, wherein the image restoration model is a generative adversarial model.

12. The apparatus according to claim 8, the operations further comprising:
obtaining a to-be-restored image; and
inputting the to-be-restored image into the image restoration model to obtain a restored image.

13. The apparatus according to claim 12, the operations further comprising:
determining second target regions to be restored in the to-be-restored image,
wherein the inputting the to-be-restored image into the image restoration model to obtain the restored image comprises:
inputting images corresponding to the second target regions to be restored into the image restoration model to obtain the restored image.

14. The apparatus according to claim 12, wherein in a case that the to-be-restored image is a to-be-restored face image, the operations further comprise:
recognizing the restored image to obtain a recognition result; and
performing identity authentication according to the recognition result.

15. A non-transitory computer readable storage medium storing computer instructions, wherein, the computer instructions are used to cause a computer to perform operations comprising:
obtaining a first image and a second image, wherein the second image is an image obtained by restoring the first image;
synthesizing images corresponding to feature points of the first image and the first image to obtain a synthesized image; and
performing training by using the second image and the synthesized image to obtain an image restoration model.

16. The non-transitory computer readable storage medium according to claim 15, wherein performing training by using the second image and the synthesized image to obtain the image restoration model, comprises:
performing synthesis based on a number of channels of the images corresponding to the feature points of the first image and a number of channels of the first image, to obtain the synthesized image.

17. The non-transitory computer readable storage medium according to claim 15, wherein the feature points of the first image are feature points of first target regions to be restored in the first image.

18. The non-transitory computer readable storage medium according to claim 15, wherein the image restoration model is a generative adversarial model.

19. The non-transitory computer readable storage medium according to claim 15, wherein the operations further comprise:
obtaining a to-be-restored image; and
inputting the to-be-restored image into the image restoration model to obtain a restored image.

20. The non-transitory computer readable storage medium according to claim 19, wherein the operations further comprise:
determining second target regions to be restored in the to-be-restored image,
wherein the inputting the to-be-restored image into the image restoration model to obtain the restored image comprises:
inputting images corresponding to the second target regions to be restored into the image restoration model to obtain the restored image.
